(19) United States
(12) Patent Application Publication
(10) Pub. No.: US 2010/0028621 A1
(43) Pub. Date: Feb. 4, 2010

(54) EMBOSSED FIBROUS STRUCTURES AND METHODS FOR MAKING SAME

(76) Inventors: Thomas Timothy Byrne, West Chester, OH (US); Kevin Benson McNeil, Loveland, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/185,458

(22) Filed: Aug. 4, 2008

(51) Int. Cl. B32B 3/00; B29C 59/04

(52) U.S. Cl. 428/195.1; 428/211.1; 156/209

(57) ABSTRACT

Embossed fibrous structures, processes for making such fibrous structures and sanitary tissue products comprising such fibrous structures

### FIELD OF THE INVENTION

The present invention relates to fibrous structures and more particularly to embossed fibrous structures comprising an embossment, processes for making such fibrous structures and sanitary tissue products comprising such fibrous structures.

### BACKGROUND OF THE INVENTION

Embossed fibrous structures and embossing processes are well known in the art. However, most prior art embossing processes rely on fibrous structure densification to impart an embossment to the fibrous structure, especially an embossment having an embossment height of greater than 200 μm. Such densification causes significant strength loss in the fibrous structure and negatively impacts other properties of the fibrous structure such as softness, caliper and/or absorbency. To achieve the densification of the fibrous structure to create the embossment, most prior art embossing systems use a relatively rigid pattern roll (constructed from steel or other metal, hard plastic such as ebonite, or other suitable material) that is loaded against a pressure roll having a deformable surface, such as rubber (referred to as “rubber-to-steel embossing”) and/or loaded against a substantially complementary pattern roll (referred to as “matched steel embossing” or male-female embossing”). When a fibrous structure is passed between two such rolls while they rotate, the fibrous structure can be permanently deformed to retain an impressed or indented pattern corresponding to raised elements on the pattern roll. The compressive force at the emboss sites in such systems is relatively high. For example, a typical converting process of a disposable paper product having a through air dried fibrous structure at a weight of 14 pounds per 3,000 square feet for a ply utilizes an embossing nip force of 100 pounds per lineal inch (pli) to emboss a fibrous structure. In a typical embossing roll configuration, a patterned roll has an outer diameter of 45.72 cm (18 inches) and a pressure roll has an outer diameter of 35.56 cm (14 inches) and a 3.175 cm (1.25 inches) thick pressure roll cover has a hardness of 100 P&J (using a 0.3175 cm (⅛ inch) diameter probe), the resulting embossing nip width formed by the rolls is about 3.81 cm (1.5 inch). The total emboss area (summation of the area of the distal ends of all emboss elements) is 10% of the total patterned roll surface area (calculated as roll outer diameter×width×pi). The resulting compressive force on the fibrous structure at the distal ends of the emboss elements therefore=(100 pounds/inch/1.5 inches wide)/10%=660 pounds per square inch. Such a force will obviously result in significant densification of the fibrous structure in the embossed sites. Such densification is known to decrease the softness of the fibrous structure, a key consumer preference and product quality target.

In addition to the decrease in softness of the fibrous structure, the fibrous structure may also experience a loss of tensile strength because as the rubber deforms around the emboss elements, it also stretches the fibrous structure down and around the emboss element. This localized stretching of the fibrous structure breaks fiber bonds and weakens the fibrous structure—a significant negative effect on product quality.

A typical rubber-to-steel embossing nip 10 created by a steel patterned roll 12 and a rubber pressure roll 14 is illustrated in FIG. 1. The fibrous structure 16 is imparted a densified embossment 18 by the rubber-to-steel embossing nip 10.

In addition to the above negatives associated with prior art embossing operations, another negative is that the soft rubber pressure roll oftentimes creates a different emboss at different operating speeds. This difference results because the pressure roll rubber is strain rate dependent—that is, the deformation of the rubber around an embossing element varies with the operating speed. As rubber is deformed faster, it is more resistant to deformation and acts “harder”. Thus, a rubber-to-steel embossing system may create consumer preferred emboss aesthetics at a speed of 300 meters per minute web speed but degrade to unacceptable aesthetics at a more preferred operating speed of 600 meters per minute.

A typical matched patterned roll (such as a matched steel patterned roll) embossing nip 20 created by a first patterned roll 22 and a second substantially complementary patterned roll 22′ is illustrated in FIG. 2. The fibrous structure 24 is imparted a densified embossment 26, especially at one or more of the edges 28 of the embossment (in the example shown in FIG. 2) where there exists the smallest clearance between a protrusion 30 of the first patterned roll 22 and a recess 32 of the second substantially complementary patterned roll 22′. Without wishing to be bound by theory, it is believed that the fibrous structure 24 gets pinched and significantly densified between the protrusion 30 of the first patterned roll 22 and the recess 32 of the second substantially complementary patterned roll 22′.

The substantially complementary nature of the first and second pattern rolls is typically such that a first patterned roll has raised areas that can nest within relieved areas of the second patterned roll and the second patterned roll has raised areas that can nest within relieved areas of the first patterned roll. A typical embossing roll fabrication process used to make such substantially complementary patterned rolls is chemical engraving of steel rolls. The first patterned roll can be chemically engraved with any desired pattern, including discrete pattern elements, linear pattern elements, or any combination thereof. The first patterned roll can then be used as a tool in the process to chemically engrave the second substantially complementary patterned roll. The first patterned roll is loaded against a roll that will become the second substantially complementary patterned roll after the roll has been uniformly coated with a chemical resist material. The first patterned roll and the roll that will become the second substantially complementary patterned roll are then rotated in synchronization. The resulting contact of the first patterned roll's raised elements removes the chemical resist material from the surface of the roll that will become the second substantially complementary patterned roll. The chemical resist material is wiped off the raised areas of the first patterned roll to allow continued removal of the chemical resist material of the other roll until the surface underlying the chemical resist material on the roll is fully exposed in the areas corresponding to the raised area pattern of the first patterned roll. Acid is then applied to the surface of the roll that will become the second substantially complementary patterned roll, resulting in the removal of a thin layer of the exposed surface. This process is repeated until the desired pattern depth is achieved in the roll thus creating the second substantially complementary patterned roll. One limitation of this process is that there is very little lateral clearance between adjacent pattern elements during engagement of the two patterns since the relieved area of the second substantially complementary patterned roll was created by the raised area of the first patterned roll. At a fully engaged position in which the raised areas of the first patterned roll extend fully into the corresponding relieved areas of the second substantially complementary patterned roll there is typically little or no lateral clearance between mating elements (typically less than 50 μm), as shown in FIG. 2. This minimal lateral clearance results in significant densification of a fibrous structure embossed between the two patterned rolls, especially when embossing consumer preferred low density substrates that typically have a thickness greater than 250 μm. Since the pattern elements have sidewall angles less than 90 degrees from the roll surface, the lateral clearance may be increased and densification minimized by reducing the engagement of the two patterned rolls. Unfortunately, the two patterned rolls must typically be completely disengaged, and thus incapable of embossing a fibrous structure, before adequate clearance and desired densification reduction can be attained for low density substrates.

One particular type of embossing process that utilizes two patterned rolls is known as the High Definition Emboss process. In this process, adhesive is applied to a first fibrous structure in a pattern corresponding to the pattern on a first patterned roll. The first fibrous structure is then bonded to a second fibrous structure by passing the first fibrous structure and the second fibrous structure between the first patterned roll and a marrying roll. The bonded fibrous structure is then passed between the first patterned roll and a second substantially complementary patterned roll. The embossments produced by this process are non-densified. While minimizing densification is preferred for product softness, a lack of any significant densification precludes imparting consumer preferred emboss area clarity. This lack of emboss pattern clarity further precludes the use of aesthetically pleasing artistic emboss images such as flowers, hearts, and the like.

Accordingly, there exists a need for an embossed fibrous structure that exhibits improved softness, strength, embossment clarity and/or embossment height compared to prior art embossed fibrous structures, sanitary tissue products employing such fibrous structures and a process for making such fibrous structures.

### SUMMARY OF THE INVENTION

The present invention fulfills the needs described above by providing a fibrous structure comprising an embossment wherein the fibrous structure exhibits improved softness, strength, embossment clarity and/or embossment height compared to prior art embossed fibrous structures, processes for making such a fibrous structure and sanitary tissue products comprising such a fibrous structure.

In one example of the present invention, a fibrous structure comprising an embossment, wherein the fibrous structure exhibits a ratio of average thickness of fibrous structure adjoining an embossment to average thickness of the embossment as measured according to the Average Thickness Test Method of less than 3 to about 1.2, is provided.

In another example of the present invention, a single- or multi-ply sanitary tissue product comprising a fibrous structure according to the present invention is provided.

In yet another example of the present invention, a process for making a fibrous structure comprising an embossment, the process comprising the step of subjecting a fibrous structure to an embossing operation that creates an embossment in the fibrous structure wherein the embossment exhibits a ratio of average thickness of fibrous structure adjoining an embossment to average thickness of the embossment as measured according to the Average Thickness Test Method of less than 3 to about 1.2, is provided.

In still yet another example of the present invention, a fibrous structure comprising an embossment, wherein the fibrous structure exhibits a ratio of average thickness of fibrous structure adjoining an embossment to average thickness of the embossment as measured by the Average Thickness Test Method of less than 3 and wherein the embossment exhibits an average wall angle as measured by the Average Wall Angle Test Method of greater than 22° and/or greater than 24° and/or greater than 26° and/or greater than 28° and/or greater than 30° and/or greater than 40°, is provided.

Accordingly, the present invention provides an embossed fibrous structure that exhibits improved softness, strength, embossment clarity and/or embossment height compared to prior art embossed fibrous structures, sanitary tissue products employing such fibrous structures and a process for making such fibrous structures.

### BRIEF DESCRIPTION OF THE DRAWINGS

FIG. 1 is a partial, exploded schematic representation of a prior art rubber-to-steel embossing operation;

FIG. 2 is a partial, exploded schematic representation of a prior art matched patterned roll embossing operation;

FIG. 3 is a partial, exploded schematic representation of an example of an embossing operation according to the present invention;

FIG. 4 is an exploded, partial schematic representation of FIG. 3;

FIG. 5 is a partial, exploded schematic representation of an example of a patterned roll according to the present invention;

FIG. 6 is a black-and-white magnified photograph of a portion of an example of a patterned roll according to the present invention;

FIG. 7 is a black-and-white magnified photograph of a portion of an example of a patterned roll according to the present invention;

FIG. 8 is a black-and-white magnified photograph of a portion of an example of a patterned roll according to the present invention;

FIG. 9 is a black-and-white magnified photograph of a portion of an example of a patterned roll according to the present invention;

FIG. 10 is a partial, side view of a schematic representation of an example of a fibrous structure according to the present invention;

FIG. 11 is a partial, side view of a schematic representation of an example of a fibrous structure according to the present invention;

FIG. 12 is a perspective view of a schematic representation of an example of a fibrous structure according to the present invention;

FIG. 13 is a perspective view of a schematic representation of an example of a fibrous structure according to the present invention;

FIG. 14 is a black-and-white magnified photograph of a portion of an example of a fibrous structure according to the present invention;

FIG. 15 is a black-and-white magnified photograph of a portion of a prior art fibrous structure;

FIG. 16 is a partial schematic representation of an example of a process for making a multi-ply fibrous structure according to the present invention;

FIG. 17 is a partial schematic representation of an example of a process for making a multi-ply fibrous structure according to the present invention;

FIG. 18 is a partial, exploded schematic representation of an example of a process for making a multi-ply fibrous structure according to the present invention;

FIG. 19 is a partial schematic representation of an example of a process for making a multi-ply fibrous structure according to the present invention;

FIG. 20 is a Mikrocad image and graph of a prior art embossed fibrous structure showing the wall angle of embossment measurement; and

FIG. 21 is a Mikrocad image and graph of an embossed fibrous structure according to the present invention showing the average wall angle of embossment measurement.

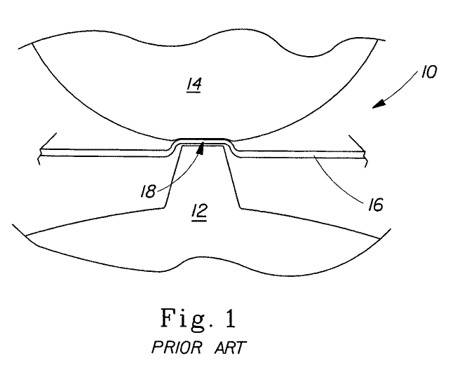

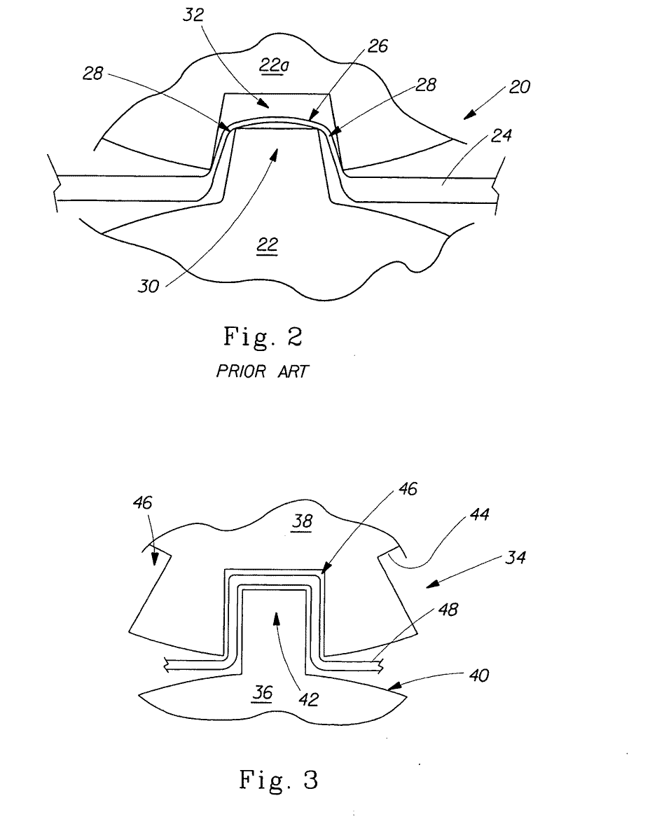

### DETAILED DESCRIPTION OF THE INVENTION

### Definitions

“Fibrous structure” as used herein means a structure that comprises one or more filaments and/or fibers. In one example, a fibrous structure according to the present invention means an orderly arrangement of filaments and/or fibers within a structure in order to perform a function. Nonlimiting examples of fibrous structures of the present invention include paper, fabrics (including woven, knitted, and non-woven), and absorbent pads (for example for diapers or feminine hygiene products).

Nonlimiting examples of processes for making fibrous structures include known wet-laid papermaking processes and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous slurry is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

The fibrous structure of the present invention may exhibit a basis weight between about 10 g/m² to about 120 g/m² and/or from about 15 g/m² to about 110 g/m² and/or from about 20 g/m² to about 100 g/m² and/or from about 30 to 90 g/m². In addition, the fibrous structure of the present invention may exhibit a basis weight between about 40 g/m² to about 120 g/m² and/or from about 50 g/m² to about 110 g/m² and/or from about 55 g/m² to about 105 g/m² and/or from about 60 to 100 g/m².

The fibrous structure of the present invention may exhibit a total dry tensile strength of greater than about 59 g/cm (150 g/in) and/or from about 78 g/cm (200 g/in) to about 394 g/cm (1000 g/in) and/or from about 98 g/cm (250 g/in) to about 335 g/cm (850 g/in). In addition, the fibrous structure of the present invention may exhibit a total dry tensile strength of greater than about 196 g/cm (500 g/in) and/or from about 196 g/cm (500 g/in) to about 394 g/cm (1000 g/in) and/or from about 216 g/cm (550 g/in) to about 335 g/cm (850 g/in) and/or from about 236 g/cm (600 g/in) to about 315 g/cm (800 g/in). In one example, the fibrous structure exhibits a total dry tensile strength of less than about 394 g/cm (1000 g/in) and/or less than about 335 g/cm (850 g/in).

In another example, the fibrous structure of the present invention may exhibit a total dry tensile strength of greater than about 196 g/cm (500 g/in) and/or greater than about 236 g/cm (600 g/in) and/or greater than about 276 g/cm (700 g/in) and/or greater than about 315 g/cm (800 g/in) and/or greater than about 354 g/cm (900 g/in) and/or greater than about 394 g/cm (1000 g/in) and/or from about 315 g/cm (800 g/in) to about 1968 g/cm (5000 g/in) and/or from about 354 g/cm (900 g/in) to about 1181 g/cm (3000 g/in) and/or from about 354 g/cm (900 g/in) to about 984 g/cm (2500 g/in) and/or from about 394 g/cm (1000 g/in) to about 787 g/cm (2000 g/in).

The fibrous structure of the present invention may exhibit an initial total wet tensile strength of less than about 78 g/cm (200 g/in) and/or less than about 59 g/cm (150 g/in) and/or less than about 39 g/cm (100 g/in) and/or less than about 29 g/cm (75 g/in).

The fibrous structure of the present invention may exhibit an initial total wet tensile strength of greater than about 118 g/cm (300 g/in) and/or greater than about 157 g/cm (400 g/in) and/or greater than about 196 g/cm (500 g/in) and/or greater than about 236 g/cm (600 g/in) and/or greater than about 276 g/cm (700 g/in) and/or greater than about 315 g/cm (800 g/in) and/or greater than about 354 g/cm (900 g/in) and/or greater than about 394 g/cm (1000 g/in) and/or from about 118 g/cm (300 g/in) to about 1968 g/cm (5000 g/in) and/or from about 157 g/cm (400 g/in) to about 1181 g/cm (3000 g/in) and/or from about 196 g/cm (500 g/in) to about 984 g/cm (2500 g/in) and/or from about 196 g/cm (500 g/in) to about 787 g/cm (2000 g/in) and/or from about 196 g/cm (500 g/in) to about 591 g/cm (1500 g/in).

The fibrous structure of the present invention may exhibit a density (measured at 95 g/in²) of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

The fibrous structure of the present invention may exhibit a total absorptive capacity of according to the Horizontal Full Sheet (HFS) Test Method described herein of greater than about 10 g/g and/or greater than about 12 g/g and/or greater than about 15 g/g and/or from about 15 g/g to about 50 g/g and/or to about 40 g/g and/or to about 30 g/g.

The fibrous structure of the present invention may exhibit a Vertical Full Sheet (VFS) value as determined by the Vertical Full Sheet (VFS) Test Method described herein of greater than about 5 g/g and/or greater than about 7 g/g and/or greater than about 9 g/g and/or from about 9 g/g to about 30 g/g and/or to about 25 g/g and/or to about 20 g/g and/or to about 17 g/g.

The fibrous structure of the present invention may be in the form of fibrous structure rolls. Such fibrous structure rolls may comprise a plurality of connected, but perforated sheets of fibrous structure, that are separably dispensable from adjacent sheets. In one example, one or more ends of the roll of fibrous structure may comprise an adhesive and/or dry strength agent to mitigate the loss of fibers, especially wood pulp fibers from the ends of the roll of fibrous structure.

The fibrous structure of the present invention may comprise one or more additives such as softening agents, temporary wet strength agents, permanent wet strength agents, bulk softening agents, lotions, silicones, wetting agents, latexes, especially surface-pattern-applied latexes, dry strength agents such as carboxymethylcellulose and starch, inks, dyes, and other types of additives suitable for inclusion in and/or on fibrous structure.

“Fiber” and/or “Filament” as used herein means an elongate particulate having an apparent length greatly exceeding its apparent width, i.e. a length to diameter ratio of at least about 10. For purposes of the present invention, a “fiber” is an elongate particulate as described above that exhibits a length of less than 5.08 cm (2 in.) and a “filament” is an elongate particulate as described above that exhibits a length of greater than or equal to 5.08 cm (2 in.).

Fibers are typically considered discontinuous in nature. Nonlimiting examples of fibers include wood pulp fibers and synthetic staple fibers such as polyester fibers.

Filaments are typically considered continuous or substantially continuous in nature. Filaments are relatively longer than fibers. Nonlimiting examples of filaments include meltblown and/or spunbond filaments. Nonlimiting examples of materials that can be spun into filaments include natural polymers, such as starch, starch derivatives, cellulose and cellulose derivatives, hemicellulose, hemicellulose derivatives, and synthetic polymers including, but not limited to polyvinyl alcohol filaments and/or polyvinyl alcohol derivative filaments, and thermoplastic polymer filaments, such as polyesters, nylons, polyolefins such as polypropylene filaments, polyethylene filaments, and biodegradable or compostable thermoplastic fibers such as polylactic acid filaments, polyhydroxyalkanoate filaments and polycaprolactone filaments. The filaments may be monocomponent or multicomponent, such as bicomponent filaments.

In one example of the present invention, “fiber” refers to papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking.

In addition to the various wood pulp fibers, other cellulosic fibers such as cotton linters, rayon, lyocell and bagasse can be used in this invention. Other sources of cellulose in the form of fibers or capable of being spun into fibers include grasses and grain sources.

“Sanitary tissue product” as used herein means a soft, low density (i.e. <about 0.15 g/cm³) web useful as a wiping implement for post-urinary and post-bowel movement cleaning (toilet tissue), for otorhinolaryngological discharges (facial tissue), and multi-functional absorbent and cleaning uses (absorbent towels). The sanitary tissue product may be convolutedly wound upon itself about a core or without a core to form a sanitary tissue product roll.

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

“Basis Weight” as used herein is the weight per unit area of a sample reported in lbs/3000 ft² or g/m².

“Machine Direction” or “MD” as used herein means the direction parallel to the flow of the fibrous structure through the fibrous structure making machine and/or sanitary tissue product manufacturing equipment.

“Cross Machine Direction” or “CD” as used herein means the direction parallel to the width of the fibrous structure making machine and/or sanitary tissue product manufacturing equipment and perpendicular to the machine direction.

“Ply” as used herein means an individual, integral fibrous structure.

“Plies” as used herein means two or more individual, integral fibrous structures disposed in a substantially contiguous, face-to-face relationship with one another, forming a multi-ply fibrous structure and/or multi-ply sanitary tissue product. It is also contemplated that an individual, integral fibrous structure can effectively form a multi-ply fibrous structure, for example, by being folded on itself.

“Average thickness of embossment” or “ET” as used herein means the average thickness of the embossment as measured across the entire embossment according to the Average Thickness Test Method described herein.

“Average thickness of embossed fibrous structure adjoining the embossment” or “FT” as used herein means the average thickness of the embossed fibrous structure adjoining an embossment on all sides of the embossment as measured according to the Average Thickness Test Method described herein.

As used herein, the articles “a” and “an” when used herein, for example, “an anionic surfactant” or “a fiber” is understood to mean one or more of the material that is claimed or described.

All percentages and ratios are calculated by weight unless otherwise indicated. All percentages and ratios are calculated based on the total composition unless otherwise indicated.

Unless otherwise noted, all component or composition levels are in reference to the active level of that component or composition, and are exclusive of impurities, for example, residual solvents or by-products, which may be present in commercially available sources.

### Embossing Nip

As shown in FIG. 3, an embossing operation according to the present invention comprises an embossing nip 34 comprising a first patterned roll 36 and a second patterned roll 38. The rolls 36 and 38 may comprise complementary or substantially complementary patterns. The first patterned roll 36 comprises a surface 40. The surface 40 may comprise one or more protrusions 42. The second patterned roll 38 comprises a surface 44. The surface 44 may comprise one or more recesses 46. At the embossing nip 34, one or more of the protrusions 42 of the surface 40 mesh with one or more of the recesses 46 of the surface 44. A fibrous structure 48 is positioned between one or more of the protrusions 42 of surface 40 and one or more of the recesses 46 of surface 44 at the embossing nip 34 and/or passes through the embossing nip 34 formed by the meshing of the protrusion 42 with the recess 46 during an embossing operation.

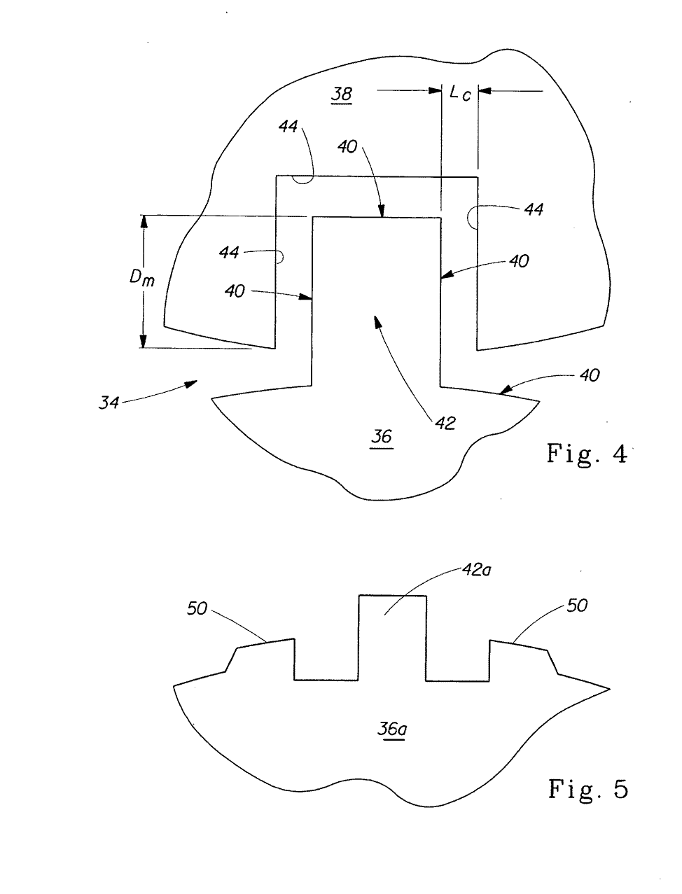

As shown in FIG. 4, which is an enlarged partial view of FIG. 3, the protrusion 42 of surface 40 of the first patterned roll 36 engages (meshes) with the second patterned roll 38 in the recess 46 present on the second patterned roll's surface 44. The meshing of protrusion 42 creates a lateral clearance (L_{C}) and a depth of mesh (D_{M}) in the recess 46.

L_{C} represents the shortest distance between any part of the entire surface 40 of the protrusion 42 of the first patterned roll 36 and any part of the entire surface 44 of the recess 46 of the second patterned roll 38 in the embossing nip 34. L_{C} may be greater than about 75 μm and/or greater than about 100 μm and/or greater than about 125 μm and/or from about 125 μm to about 700 μm and/or to about 600 μm and/or to about 500 μm and/or to about 400 μm and/or to about 300 μm and/or to about 280 μm. In one example, the L_{C} is from about 75 μm to about 700 μm. In one example, the L_{C} of one protrusion to one recess may be different for another protrusion to another recess on the same patterned rolls.

For a given set of patterned rolls, L_{C} may depend upon the fibrous structure being embossed by the patterned rolls. For example, a typical fibrous structure may exhibit a thickness of 254-381 μm (10-15 mils) and the above L_{C} values are suitable for embossing such a fibrous structure having that thickness. However, if a fibrous structure exhibited a thickness of 762 μm (30 mils) or greater, then the L_{C} between the patterned rolls may have to be greater to achieve the optimal embossments in the fibrous structure. Accordingly, the L_{C} may be from about 25% to about 85% and/or from about 30% to about 80% and/or from about 40% to about 80% of the thickness of the fibrous structure being embossed.

D_{M} represents the greatest distance that protrusion 42 overlaps the recess 46 in the embossing nip 34. D_{M} may be greater than about 254 μm (10 mils) and/or greater than about 381 μm (15 mils) and/or greater than about 508 μm (20 mils) and/or to about 2032 μm (80 mils) and/or to about 1524 μm (60 mils) and/or to 1016 μm (40 mils) and/or to about 889 μm (35 mils) and/or to about 762 μm (30 mils) and/or from about 381 μm (15 mils) to about 2032 μm (80 mils) and/or from about 508 μm (20 mils) to about 1524 μm (60 mils) and/or from about 508 μm (20 mils) to about 1016 μm (40 mils). In one example, the D_{M} of one protrusion into one recess may be different for another protrusion into another recess on the same patterned rolls.

In one example, the D_{M} is chosen to create a subtle background image. In another example, the D_{M} is chosen to create a distinct sheet impression.

The nip pressure within the embossing nip 34 when a fibrous structure is present within the embossing nip 34 may be less than about 80 pli and/or less than about 60 pli and/or less than about 40 pli and/or less than about 20 pli and/or less than about 10 pli to about 1 pli and/or to about 2 pli and/or to about 5 pli. In one example, the nip pressure in the embossing nip 34 when a fibrous structure is present within the embossing nip 34 is from about 2 pli to about 10 pli and/or from about 5 pli to about 10 pli.

When a fibrous structure is present within the embossing nip 34, the nip pressure within the embossing nip 34 results in a deformation force (strain) being applied to the fibrous structure, in all directions including and between the machine and cross machine directions, which may result in an embossment being created in the fibrous structure. In one example, the fibrous structure during the embossing operation is subjected to a strain in all directions including and between the machine and cross machine directions such that the fibrous structure experiences a maximum and a minimum strain that differs by less than 25% across all directions.

The strain required to achieve a desired embossment appearance varies with the fibrous structure's properties. For example, a fibrous structure with higher stretch may require more strain to achieve a desired permanent depth of emboss (D_{E}) than a fibrous structure with lower stretch. It has also been found that discrete protrusions (i.e., dot embossing elements) such as dots can more easily be embossed and attain permanent deformation than line protrusions (i.e., line embossing elements). Thus, given a desired pattern and fibrous structure's properties, the L_{C} and D_{M} can be selected to achieve the target strain and corresponding embossment appearance in that portion of the emboss pattern.

### Patterned Rolls

The embossing operation of the present invention utilizes two or more patterned rolls that create a nip pressure, when engaged with one another to form an embossing nip, sufficient to create deformations (embossments) in a fibrous structure present within the embossing nip.

The patterned rolls may comprise complementary patterns. The patterned rolls may be made from the same material or different materials. Nonlimiting examples of suitable materials for the patterned rolls may include steel, ebonite, aluminum, other metals, ceramic, plastics, rubber, synthetic rubber and mixtures thereof.

The patterned rolls may be made by any suitable process known in the art. Non-limiting examples of suitable processes include laser engraving hard plastic (ebonite) or ceramic or other material suitable for laser ablation to remove material and create embossing elements, chemical engraving of steel or other materials to remove material and create embossing elements, machining aluminum or steel or other metals to remove material and create embossing elements, metallizing processes to build up embossing elements, sintering processes to build up embossing elements and/or other means known in the art to remove material or build up material and achieve a surface topography with the desired pattern and clearances between mating embossing elements.

In one example, the patterned rolls are made by laser engraving a pattern onto a surface of a roll, such as an Ebonite roll.

The patterned rolls may comprise protrusions and/or recesses (i.e., dot and/or line embossing elements) in any configuration or pattern and at any frequency desired.

It has been surprisingly discovered that open zones between protrusions on a patterned roll may result in localized fibrous structure strain around the protrusions at the periphery of the open zone to be less than needed for causing deformation (i.e., formation of an embossment) of the fibrous structure as there is ample “untrapped” fibrous structure nearby to flow toward the protrusion when the fibrous structure is present in the embossing nip.

As shown in FIG. 5, a first patterned roll 36′ may comprise a strain equalizing element 50 adjoining one or more protrusions 42′. The strain equalizing element 50 is not intended to create an embossment in a fibrous structure when the fibrous structure is present in an embossing nip comprising the first patterned roll 36′ and another roll. The strain equalizing element 50 provides a means of restricting fibrous structure flow toward the protrusion present on a patterned roll adjoining relatively large open areas in the emboss pattern present on a patterned roll, thereby ensuring similar strain in the fibrous structure in all areas of the emboss pattern.

In another example, the strain around an element may be controlled by machining a pair of patterned rolls so that a protrusion on a first patterned roll would have a first L_{c} for one side and a second, different L_{C} for another side when the protrusion is engaged with a recess on the other patterned roll.

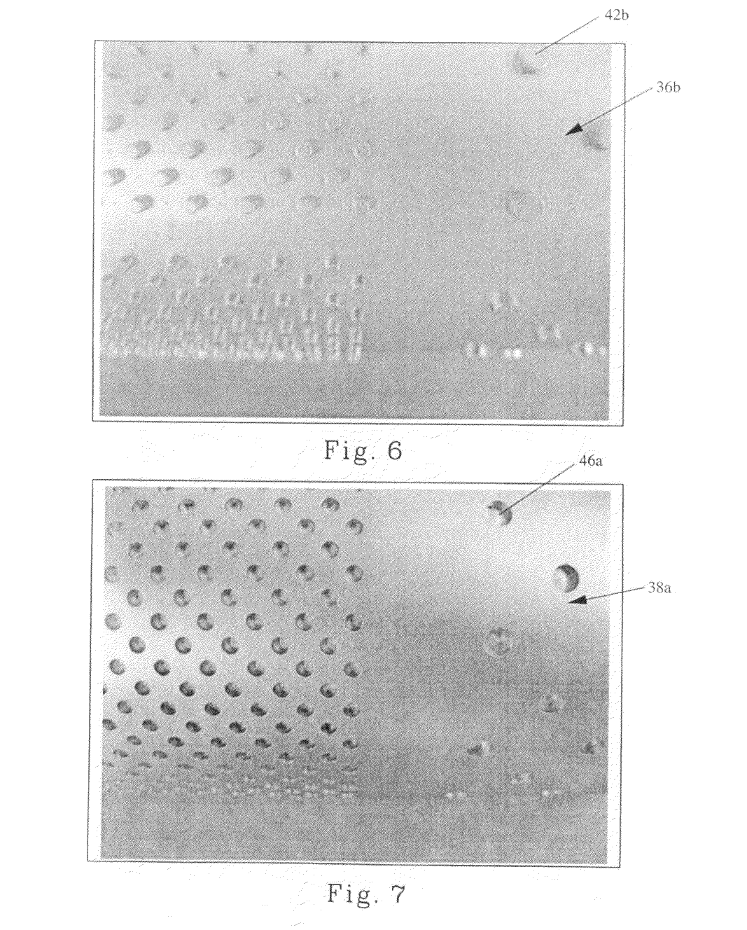

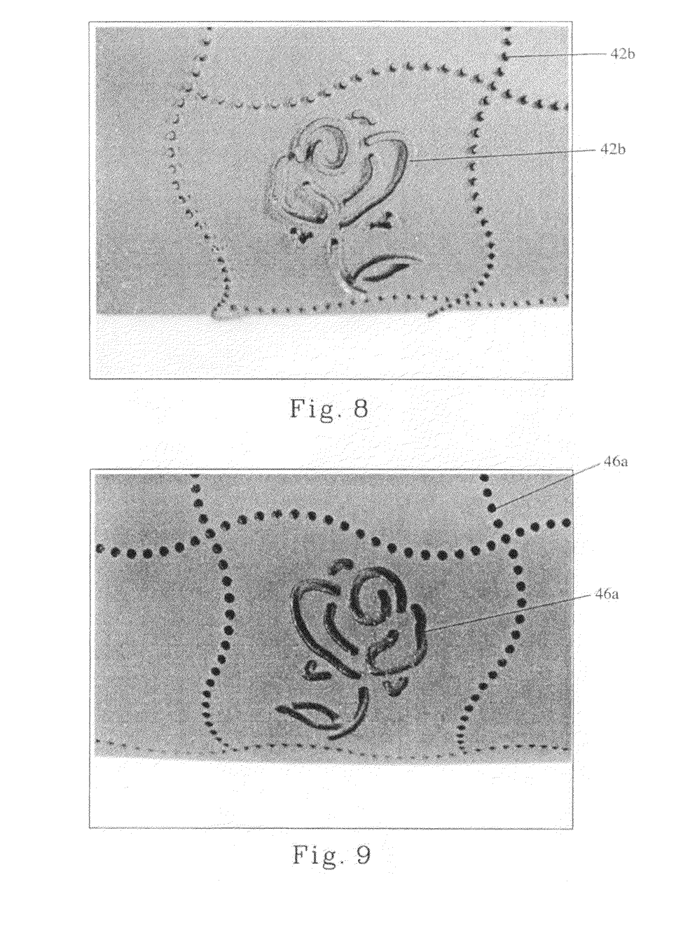

In one example as shown in FIG. 6, a first patterned roll 36″ may comprise one or more protrusions 42″ (i.e., male protuberances). As shown in FIG. 7, a second patterned roll 38′ may comprise one or more recesses 46′ (i.e., female recesses). In one example, an embossing nip is formed by engaging the first patterned roll 36″ and the second patterned roll 38′ such that at least one protrusion 42″ of the first patterned roll 36″ meshes with at least one recess 46′ of the second patterned roll 38′. The protrusions 42″ and recesses 46′ may be discrete dot and/or line embossing elements as shown in FIGS. 6-9.

At least one of the first and second patterned rolls of the present invention may exhibit an external diameter of less than about 35 cm (14 in.) and/or less than about 25 cm (9.8 in.). In one example, both the first and second patterned rolls exhibit and external diameter of less than about 35 cm (14 in.) and/or less than about 25 cm (9.8 in.).

In one example, at least one of the first and second patterned rolls is capable of creating dot embossments in a fibrous structure. In another example, at least one of the first and second patterned rolls is capable of creating line element embossments in a fibrous structure. In yet another example, at least one of the first and second patterned rolls is capable of creating dot and line element embossments.

### Non-limiting Synthesis Example

A patterned roll according to the present invention may be made as follows. Fabricate a steel roll body. The steel roll body has a face width of 266.7 cm (105 inches) and an outer diameter of 29.21 cm (11.5 inches) with a wall body thickness of 3.492 cm (1⅜ inch). Apply an outer cover of Ebonite to the steel roll body. The Ebonite has a hardness of 80-85 Shore D, and is coated onto the steel roll body at a little over a 0.635 cm (¼ inch) thick. The coated roll is then ground to 30.48 cm (12 inches) to reduce the TIR to 25.4 μm (0.001 inch) or less. The ground roll is then laser engraved using a CO₂ laser to produce any desired emboss pattern (male or female) in the patterned roll. Once laser engraved, the patterned roll is then grit blasted to deburr the roll face. A patterned roll with a complementary pattern such that the two patterned rolls exhibit a D_{M} and L_{C} according to the present invention may be made by the laser engraving a complementary pattern into another Ebonite coated roll.

### Fibrous Structure

The fibrous structure of the present invention may be made by an embossing operation. The fibrous structure made by an embossing operation of the present invention that utilizes one or more patterned rolls comprises one or more embossments. In one example, the fibrous structure of the present invention comprises a plurality of embossments. The embossments may comprise discrete dot and/or line element embossments. In one example, the fibrous structure of the present invention comprises a line element embossment at least partially surrounded, such as on at least two sides of the line element embossment, by a line of a plurality of dot embossments. The dot embossments in the fibrous structure of the present invention may be any desired shape, for example circles, ellipses, squares, triangles. The line element embossments may be of any width, length, radius of curvature.

One or more embossments present in the fibrous structure of the present invention may exhibit a ratio of average thickness of fibrous structure adjoining an embossment to average thickness of the embossment of less than about 3 and/or less than about 2.75 and/or less than about 2.5 and/or less than about 2 and/or to about 1.2 and/or to about 1.3 and/or to about 1.4 and/or to about 1.5 as measured according to the Average Thickness Test Method described herein. In one example, one or more embossments present in the fibrous structure of the present invention exhibits a ratio of average thickness of fibrous structure adjoining an embossment to average thickness of the embossment of from about 3 to about 1.2 and/or from about 2.75 to about 1.2 and/or from about 2.5 to about 1.5 as measured according to the Average Thickness Test Method described herein.

At least one of the embossments in the fibrous structure of the present invention may exhibit an embossment height of greater than about 200 μm and/or greater than about 400 μm and/or greater than about 500 μm and/or greater than about 600 μm and/or greater than about 1000 μm and/or from about 200 μm to about 2500 μm and/or from about 250 μm to about 2000 μm and/or from about 300 μm to about 1500 μm and/or from about 400 μm to about 1500 μm as measured by the Embossment Height Test Method described herein. In one example, at least one of the embossments in the fibrous structure exhibits an embossment height of from about 250 μm to about 500 μm.

The fibrous structure of the present invention may exhibit a flexural rigidity of less than about 10 cm and/or less than about 8 cm and/or less than about 6 cm and/or to about 1 cm and/or to about 3 cm as measured according to the Flexural Rigidity Test Method described herein.

The fibrous structure of the present invention may exhibit a total dry tensile of greater than about 59 g/cm.

In one example, the fibrous structure of the present invention may comprise a softening agent. In another example, the fibrous structure of the present invention may comprise a temporary wet strength agent and/or a permanent wet strength agent. Other suitable additives known to those skilled in the art may also be included in and/or on the fibrous structure of the present invention.

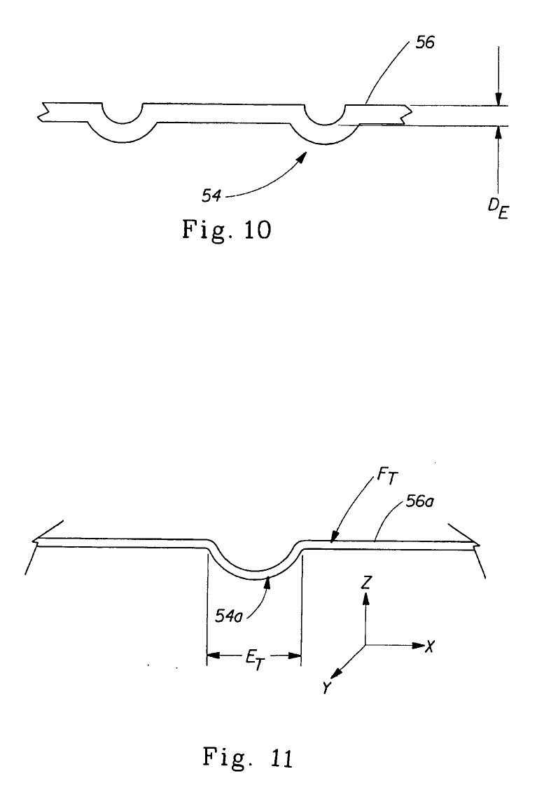

As shown in FIG. 10, in one example, the D_{M} between a protrusion on a first patterned roll and a recess on a second patterned roll is selected to produce a D_{E} in an embossment 54 within an embossed fibrous structure 56 of the present invention of greater than about 200 μm and/or greater than about 400 μm and/or greater than about 500 μm and/or greater than about 550 μm and/or from about 200 μm to about 2500 μm and/or from about 300 μm to about 2000 μm and/or from about 400 μm to about 1500 μm and/or from about 500 μm to about 1000 μm. In one example, the D_{E} of at least one embossment in a fibrous structure of the present invention is from about 200 μm to about 600 μm. The D_{E} is measured by the Embossment Height Test Method described herein.

As shown in FIG. 11, an embossed fibrous structure 56′ of the present invention comprises an embossment 54′ wherein the embossment 54′ exhibits a ratio of average thickness of embossed fibrous structure 56′ adjoining an embossment 54′ (FT) to average thickness of the embossment 54′ (ET) of less than about 3 and/or less than about 2.75 and/or less than about 2.5 and/or to about 1.2 and/or to about 1.3 and/or to about 1.4 and/or to about 1.5 as measured by the Average Thickness Test Method described herein.

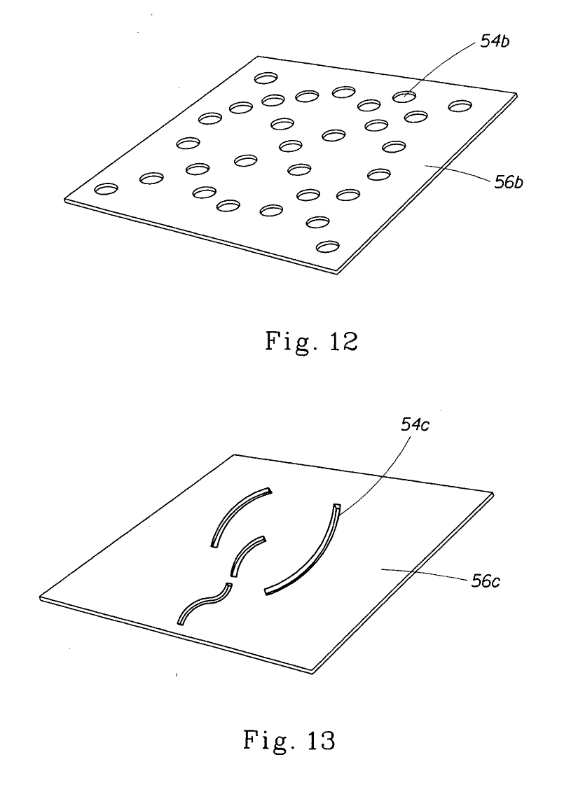

FIGS. 12 and 13 illustrate examples of embossed fibrous structures 56″, 56′″ of the present invention that comprise discrete dot embossments 54″ (FIG. 12) and line element embossments 54′″ (FIG. 13).

One or more of the embossed fibrous structures of the present invention may be utilized as a single-ply or multi-ply sanitary tissue product. In one example, one or more the embossed fibrous structures of the present invention are combined with one or more other fibrous structures, the same or different, to form a multi-ply fibrous structure. The multi-ply fibrous structure may be utilized as a multi-ply sanitary tissue product.

### Process for Making a Fibrous Structure

An embossed fibrous structure of the present invention may be made by passing a fibrous structure, previously embossed or unembossed, through an embossing nip formed by two or more rolls, at least one of which is a patterned roll that imparts one or more embossments into the fibrous structure.

In one example, an embossed fibrous structure of the present invention is made by a process comprising the step of subjecting a fibrous structure to an embossing operation that creates an embossment in the fibrous structure wherein the embossment exhibits a ratio of average thickness of fibrous structure adjoining an embossment to average thickness of the embossment of less than 3 to about 1.2 as measured according to the Average Thickness Test Method described herein.

As shown in FIG. 3, the embossing operation may comprise passing a fibrous structure 48 through an embossing nip 34 formed by a first patterned roll 36 and a second patterned roll 38 of the present invention. The first patterned roll 36 may comprise a male emboss pattern comprising one or more protrusions 42, which may be discrete dot and/or line embossing elements. The first patterned roll 36 may further comprise a strain equalizing element 50 (shown in FIG. 5) adjoining one or more of the protrusions 42 present on the first patterned roll 36. The second patterned roll 38 may comprise a female emboss pattern comprising one or more recesses 46, which may be discrete dot and/or line embossing elements, into which one or more of the protrusions 42 of the first patterned roll 36 mesh. The D_{M} of the first and second patterned rolls 36, 38 may be greater than about 254 μm (10 mils) and/or greater than about 381 μm (15 mils) and/or greater than about 508 μm (20 mils) and/or to about 2032 μm (80 mils) and/or to about 1524 μm (60 mils) and/or to 1016 μm (40 mils) and/or to about 889 μm (35 mils) and/or to about 762 μm (30 mils) and/or from about 381 μm (15 mils) to about 2032 μm (80 mils) and/or from about 508 μm (20 mils) to about 1524 μm (60 mils) and/or from about 508 μm (20 mils) to about 1016 μm (40 mils). The L_{C} between the first and second patterned rolls 36, 38 may be greater than about 75 μm and/or from about 75 μm to about 700 μm.

The embossing operation may apply a nip pressure, via the embossing nip, to the fibrous structure of less than about 80 pli and/or less than about 60 pli and/or less than about 40 pli and/or less than 20 pli and/or less than about 10 pli to about 1 pli and/or to about 2 pli and/or to about 5 pli during creation of the embossment in the fibrous structure. In one example, the nip pressure in the embossing nip 34 when a fibrous structure is present within the embossing nip 34 is from about 2 pli to about 10 pli and/or from about 5 pli to about 10 pli.

The embossment made in the fibrous structure via this process may be a dot embossment and/or a line element embossment.

In one example, complementary pattern embossing elements (protrusions and recesses) are provided on a first patterned roll and a second patterned roll such that when the two rolls are rotated together in synchronization, an embossing nip is formed which is capable of imparting an embossment to a fibrous structure passing through the embossing nip.

The embossing operation of the process of the present invention and embossments made in the fibrous structure of the present invention may be phase registered with other features imparted in the fibrous structure.

### Non-limiting Example of Fibrous Structure

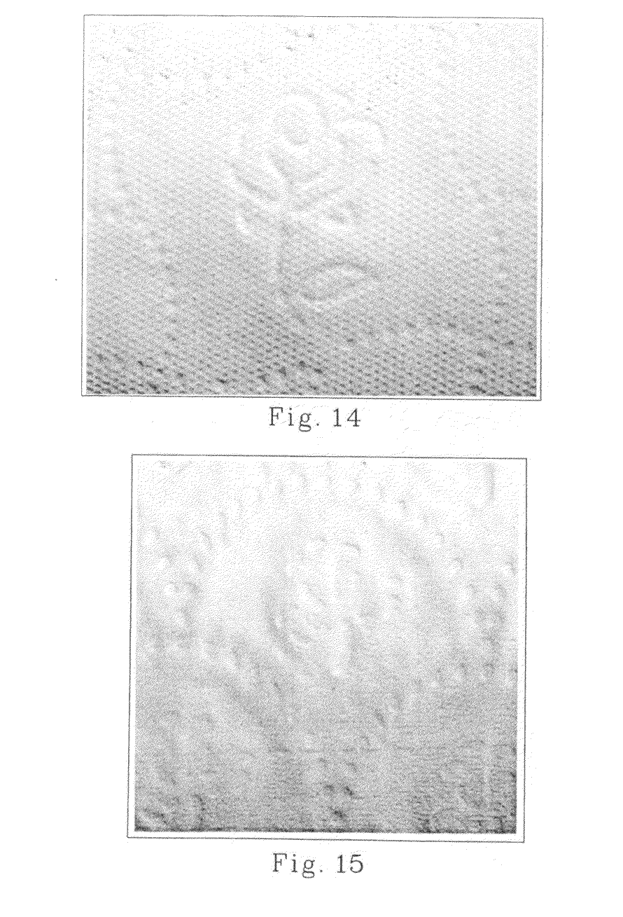

A fibrous structure that has been passed through an embossing nip according to the present invention is shown in FIG. 14. The unembossed fibrous structure that enters the embossing nip exhibited a thickness of (0.015 in.) and the L_{C} between the first and second patterned rolls forming the embossing nip was (0.008 in.) and the D_{M} of the protrusions of the first patterned roll into the recesses of the second patterned roll was (0.025 in.).

It is clear that the embossment (the line element embossments that form the flower) in the fibrous structure as shown in FIG. 14 made according to the present invention exhibits much more clarity and definition than a comparable embossment (the line element embossments that attempt to form some flower shape) in a prior art fibrous structure as shown in FIG. 15 made by a rubber-to-steel embossing operation.

### Process for Making Multi-Ply Fibrous Structure

One or more embossed fibrous structures of the present invention may be combined with another fibrous structure, either the same or different, to form a multi-ply fibrous structure.

In one example, a process for making a multi-ply fibrous structure comprises the step of combining an embossed fibrous structure of the present invention with another fibrous structure to form a multi-ply fibrous structure.

In another example, a process for making a multi-ply fibrous structure comprises the steps of:
a. providing a first embossed fibrous structure according to the present invention;
b. providing a second fibrous structure;
c. bonding the first and second fibrous structures together to form a multi-ply fibrous structure.

The second fibrous structure may be an embossed fibrous structure, such as a rubber-to-steel embossed fibrous structure. In one example, the second fibrous structure may be an embossed fibrous structure according to the present invention.

The first and second fibrous structures may comprise the same emboss pattern or they may be different.

The bonding step may comprise applying an adhesive to at least one of the fibrous structures. The adhesive may be applied to one or more surfaces of the fibrous structure by any suitable process known to those skilled in the art. Non-limiting examples of suitable processes include smooth applicator roll process, patterned applicator roll, gravure roll application process, slot extrusion, spray process, permeable fluid applicator process and combinations thereof. The adhesive may cover 100% of the surface area of the fibrous structure or some portion of the surface area of the fibrous structure. The less adhesive coverage the less negative impact to softness of the multi-ply fibrous structure. A non-limiting example of a suitable adhesive for use in the processes of the present invention includes polyvinyl alcohol. In one example, the adhesive is a polyvinyl alcohol that has a viscosity at 14% solids of 10,000 centipoise.

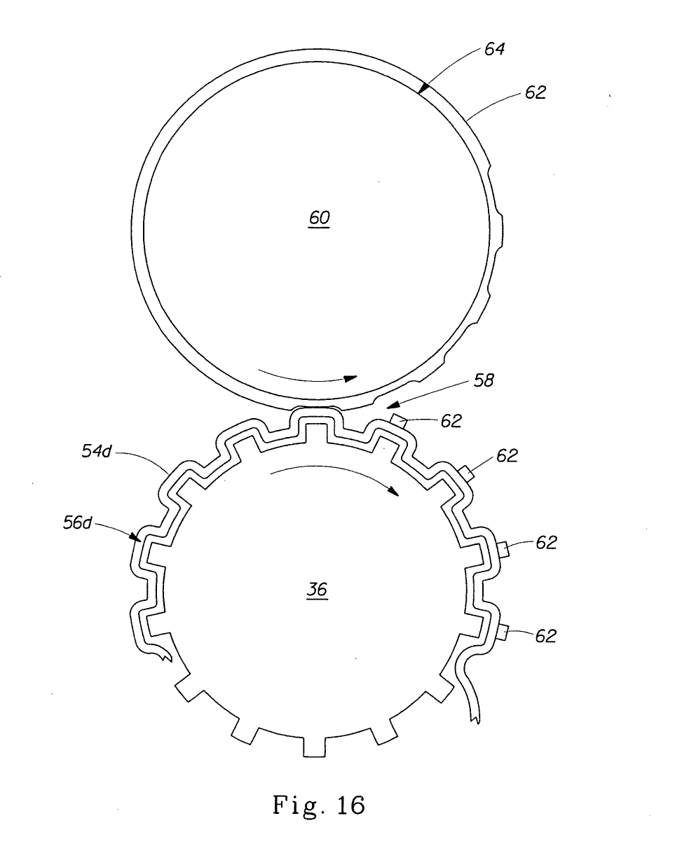

As shown in FIG. 16, an embossed fibrous structure 56″″ may remain on a first patterned roll 36 as the roll rotates past the embossing nip (not shown). The embossed fibrous structure is typically deformed in the z-direction such that after the emboss nip, fibrous structure zones between embossments 54″″ are deformed down into the relieved portion of the first patterned roll 36, leaving only the embossments 54″″ of the embossed fibrous structure 56″″ at the outer periphery of the first patterned roll 36. As the fibrous structure passes an adhesive application zone 58, such as a smooth applicator roll 60 which operates in conjunction with a gravure roll (not shown) to supply a uniform thin layer of adhesive 62 to the surface 64 of the smooth applicator roll 60, adhesive 62 is applied to the embossed fibrous structure 56″″ at the embossments 54″″ of the embossed fibrous structure 56″″. Typically the adhesive is applied only to the embossments 54″″ of the embossed fibrous structure 56″″ and typically all embossments 54″″ have adhesive 62 applied to them. This approach limits the adhesive 62 in the embossed fibrous structure 56″″ (better for softness) since the embossed area is usually a small portion of the total embossed fibrous structure 56″″ and helps retain the embossment 54″″ clarity by holding down or retaining the embossed fibrous structure deformation at the embossment 54″″.

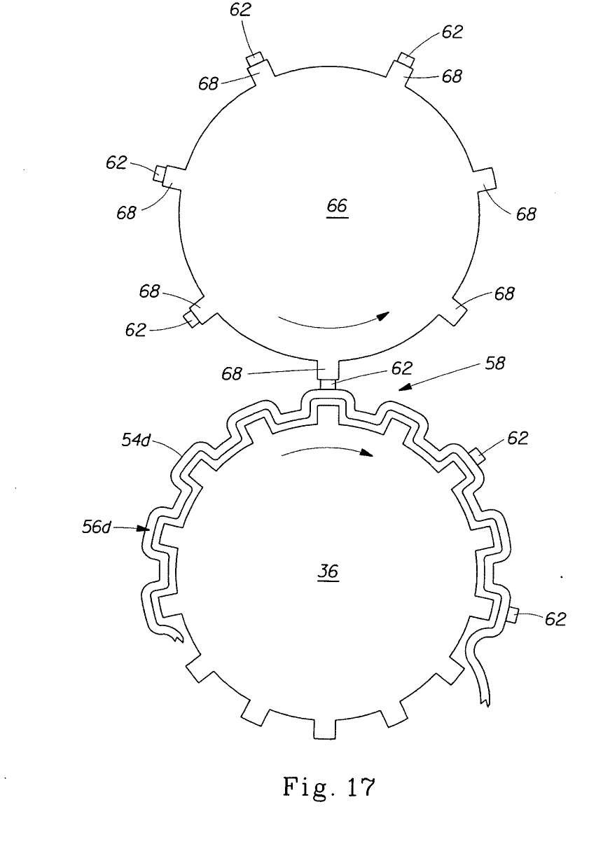

In another example as shown in FIG. 17, adhesive 62 is only applied to a portion of the embossments 54″″ in an embossed fibrous structure 56″″—enough to achieve necessary bond strength between two or more combined plies of fibrous structure but low enough to allow movement between the plies in many locations to improve drape and softness impression of the multi-ply fibrous structure. Adhesive application to only a portion of the embossments 54″″ can be achieved by a patterned applicator roll 66 having raised areas 68 that correspond to a portion of the embossments 54″″ in the embossed fibrous structure 56″″.

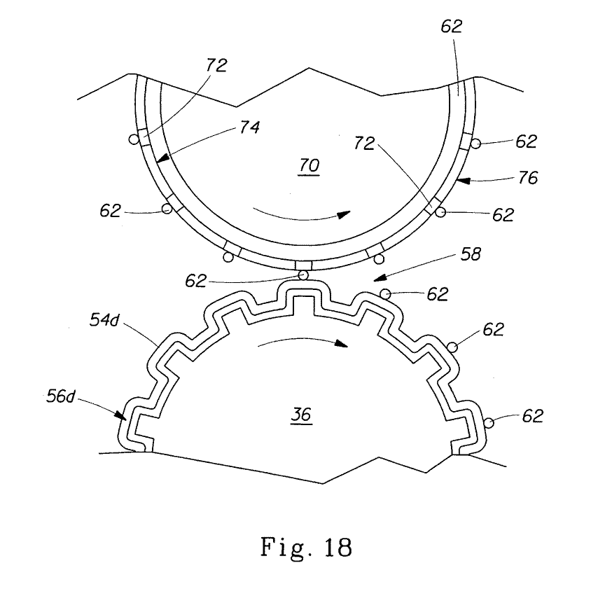

In yet another example as shown in FIG. 18, adhesive 62 is applied to embossments 54″″, either all embossments or some portion of each embossment 54″″ or some portion of embossments 54″″ or some portion of portion of individual embossments 54″″ such as only adhesive application at opposite ends of a line element embossment by way of a permeable fluid applicator roll 70. Holes 72 of the permeable applicator roll 70 may be registered to an emboss pattern on a first patterned roll 36. The adhesive 62 becomes deliverable to an embossment 54″″ as the adhesive 62 passes from an interior surface 74 of the permeable applicator roll 70 through hole 72 to an exterior surface 76 of the permeable fluid applicator roll 70. The permeable fluid applicator roll process can provide a higher volume of adhesive at each adhesive transfer point. The drop of adhesive may also be relatively large compared to the thickness of adhesive on a smooth applicator roll. The higher volume of adhesive, or drop size, also allows a greater operating distance between the permeable fluid applicator roll and patterned roll while still ensuring adequate adhesive transfer to the fibrous structure, thereby minimizing compression on the fibrous structure. A non-limiting example of a suitable permeable fluid applicator roll is described in U.S. Patent Publication No. 2006/0193985 to McNeil et al.

After adhesive is applied to one or more of the fibrous structure plies, the plies are brought into proximity. If a fibrous structure other than the embossed fibrous structure of the present invention is embossed, its emboss pattern is typically complementary to the emboss pattern on the embossed fibrous structure ply of the present invention and is brought into proximity in a registered manner. For example, one fibrous structure ply may have embossments that provide permanently deformed zones that extend upward in the z-direction. When these embossments are registered with embossments of an embossed fibrous structure ply of the present invention, the embossed z-direction embossments in the other ply may provide support for unembossed zones in the embossed fibrous structure ply of the present invention, thus providing a consumer preferred undulating topography that is perceived as soft and pillowy. After the plies are brought into proximity (in a registered manner if desired), the resulting multi-ply fibrous structure is passed through a marrying roll nip.

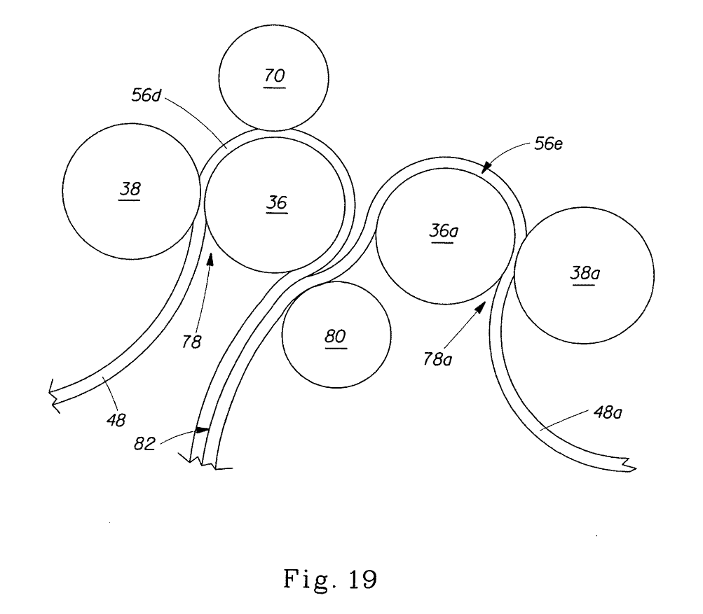

In one example of a process for making a multi-ply fibrous structure, as represented in FIG. 19, a first fibrous structure 48 is embossed by embossing nip 78 formed by a first patterned roll 36 and a second patterned roll 38 to produce an embossed fibrous structure 56″″. An adhesive is then applied to portions of a portion of the individual embossments by a permeable fluid applicator roll 70. A second fibrous structure 48′ is embossed by embossing nip 78′ formed by a first patterned roll 36′ and a second patterned roll 38′ to produce an embossed fibrous structure 56′″″. The embossed fibrous structure 56″″ and embossed fibrous structure 56′″″ are brought into proximity of one another and are compressed together upon loading of a marrying roll 80 against the first patterned roll 36 via pneumatic or hydraulic or other suitable means to achieve the desired compressive force. This compressive force bonds the two embossed fibrous structures 56″″, 56′″″ (plies) together while the embossed fibrous structure 56″″ is still positioned in its embossing location—that is, the embossments of the embossed fibrous structure 56″″ are still located on the corresponding emboss pattern elements (for example, protrusions) on the first patterned roll 36 and the adhesive that has been applied to the embossed fibrous structure 56″″ is also still aligned with the emboss pattern elements (for example, protrusions). The compressive force thus bonds the two embossed fibrous structures 56″″, 56′″″ together to form an embossed multi-ply fibrous structure 82.

The process for making a multi-ply fibrous structure according to the present invention avoids and/or significantly reduces the negatives associated with known methods for making embossed multi-ply fibrous structures since the process of the present invention significantly reduces the total densification of the embossed multi-ply fibrous structure compared to known processes. The total densification of the embossed area in an embossed multi-ply fibrous structure is the combined effect of embossing densification, adhesive application densification, and lamination densification. In prior art systems, significant densification can occur in all three transformations. The process of the present invention permits the use of significantly lower embossing pressures, adhesive application pressures and lamination pressures to achieve improved embossed fibrous structures. As a result, the various rolls utilized in the process of the present invention can have significantly smaller external diameters—for example external diameters of less than 35 cm (14 in.) and/or less than about 25 cm (9.8 in.) In addition, a low pressure marrying roll nip (for example, less than about 40 pli and/or less than about 20 pli and/or less than about 10 pli to about 1 pli and/or to about 2 pli and/or to about 5 pli) for laminating the fibrous structures together is achievable due to the fact that a higher tack, high viscosity adhesive, such as polyvinyl alcohol (14% solids, 10,000 centipoise) can be used. Such an adhesive is more effective at creating bond strength than lower tack, low viscosity adhesives, which are typically required to be used in adhesive application processes other than the permeable fluid applicator process. As a result, the amount of compressive force required in the marrying roll nip is significantly less than is required for existing marrying roll nip processes.

In one example, the embossing and laminating equipment suitable for use in the present invention may be combined into a modular unit such that the modular unit is capable of being inserted into a papermaking machine at a desired location, such as in the converting section of the papermaking machine.

The embossing operation of the present invention and/or laminating process of the present invention may operate at any suitable speed within a papermaking machine such as greater than about 500 feet per minute (fpm) and/or greater than about 1000 fpm and/or greater than about 1500 fpm and/or greater than about 1800 fpm and/or greater than about 2000 fpm and/or greater than about 2400 fpm and/or greater than about 2500 fpm.

After embossing and laminating, the multi-ply fibrous structure can be conveyed to other fibrous structure processing stations such as lotioning, coating, printing, slitting, folding, perforating, winding, tuft-generating, and the like. Alternatively, some of these other fibrous structure processing transformations may occur prior to the embossing and laminating transformations.

### Test Methods

Unless otherwise indicated, all tests described herein including those described under the Definitions section and the following test methods are conducted on samples, test equipment and test surfaces that have been conditioned in a conditioned room at a temperature of 73° F.±4° F. (about 23° C.±2.2° C.) and a relative humidity of 50%±10% for 12 hours prior to the test. Further, all tests are conducted in such conditioned room.

### Average Thickness Test Method

The average thickness measurements for an embossed fibrous structure are measured as follows. A high resolution x-ray tomography system, the Scanco μCT40 (serial # 07030700, ID# 4286, Scanco Medical AG), is used to visualize and record x-ray absorption of fibrous structure samples in the three-dimensional Cartesian coordinates system. A fibrous structure sample irradiated with X-rays, transmits its radiation for collection into an X-ray scintillator to transform the X-rays into electromagnetic radiations readable by the CCD elements of an array camera. Images are taken from different angles to reconstruct the 3D space. An obtained 3D dataset, the produced volume image, is analyzed via Matlab® image processing software application to determine the relative basis weight, thickness and density of the 3D fibrous structures.

Specified emboss and non-emboss areas of a fibrous structure sample are defined and cut to 20 mm diameter and placed in a custom rotating short sample tube for sample suspension in the micro-tomography instrument. Image acquisition parameters of the 3-D isotropic scan included High resolution (1000 projections) with the x-ray tube set at a current of 180 μA and peak energy of 35 kVp, with a 300 msecond integration time. Averaging is set at 10. A slice increment of approximately 10 μm is acquired (about 200-300 slices depending on sample thickness) over an imaging time of approximately 4-7 hours. Each slice consisting of 1000 projections was used to reconstruct the CT image in a 2048×2048 pixel matrix, with a pixel resolution of 10 μm.

Matlab® Image Analysis is used to analyze the volume image slice by slice to create 2-D images that represent features along the z, or thickness direction, i.e., mass, top layer image, bottom layer image, thickness of sheet, and “volume density” of the sample. The thickness image is selected to draw and measure user defined regions of interest (ROI) to obtain thickness data of the fibrous structure sample. Embossment ROI's are drawn within the center of an embossment away from the embossment wall transition area. Non-emboss areas selected for thickness measurements surrounding the embossment being measured are drawn in polygon form in embossment free-areas of the fibrous structure sample. Average thickness of embossment is the average thickness of the embossment as measured by this method. Average thickness of embossed fibrous structure adjoining the embossment is the average thickness of the embossment free-areas surrounding the embossment.

### Embossment Height Test Method

Embossment height is measured using a GFM Primos Optical Profiler instrument commercially available from GFMesstechnik GmbH, Warthestraβe 21, D14513 Teltow/Berlin, Germany. The GFM Primos Optical Profiler instrument includes a compact optical measuring sensor based on the digital micro mirror projection, consisting of the following main components: a) DMD projector with 1024×768 direct digital controlled micro mirrors, b) CCD camera with high resolution (1300×1000 pixels), c) projection optics adapted to a measuring area of at least 27×22 mm, and d) recording optics adapted to a measuring area of at least 27×22 mm; a table tripod based on a small hard stone plate; a cold light source; a measuring, control, and evaluation computer; measuring, control, and evaluation software ODSCAD 4.0, English version; and adjusting probes for lateral (x-y) and vertical (z) calibration.

The GFM Primos Optical Profiler system measures the surface height of a sample using the digital micro-mirror pattern projection technique. The result of the analysis is a map of surface height (z) vs. xy displacement. The system has a field of view of 27×22 mm with a resolution of 21 microns. The height resolution should be set to between 0.10 and 1.00 micron. The height range is 64,000 times the resolution.

To measure a fibrous structure sample do the following:

1. Turn on the cold light source. The settings on the cold light source should be 4 and C, which should give a reading of 3000K on the display;
2. Turn on the computer, monitor and printer and open the ODSCAD 4.0 Primos Software.
3. Select “Start Measurement” icon from the Primos taskbar and then click the “Live Pic” button.
4. Place a 30 mm by 30 mm sample of fibrous structure product conditioned at a temperature of 73° F.±2° F. (about 23° C.±1° C.) and a relative humidity of 50%±2% under the projection head and adjust the distance for best focus.
5. Click the “Pattern” button repeatedly to project one of several focusing patterns to aid in achieving the best focus (the software cross hair should align with the projected cross hair when optimal focus is achieved). Position the projection head to be normal to the sample surface.
6. Adjust image brightness by changing the aperture on the lens through the hole in the side of the projector head and/or altering the camera “gain” setting on the screen. Do not set the gain higher than 7 to control the amount of electronic noise. When the illumination is optimum, the red circle at bottom of the screen labeled “I.O.” will turn green.
7. Select Technical Surface/Rough measurement type.
8. Click on the “Measure” button. This will freeze on the live image on the screen and, simultaneously, the image will be captured and digitized. It is important to keep the sample still during this time to avoid blurring of the captured image. The image will be captured in approximately 20 seconds.
9. If the image is satisfactory, save the image to a computer file with “.omc” extension. This will also save the camera image file “.kam”.
10. To move the date into the analysis portion of the software, click on the clipboard/man icon.
11. Now, click on the icon “Draw Cutting Lines”. Make sure active line is set to line 1. Move the cross hairs to the lowest point on the left side of the computer screen image and click the mouse. Then move the cross hairs to the lowest point on the right side of the computer screen image on the current line and click the mouse. Now click on “Align” by marked points icon. Now click the mouse on the lowest point on this line, and then click the mouse on the highest point on this line. Click the “Vertical” distance icon. Record the distance measurement. Now increase the active line to the next line, and repeat the previous steps, do this until all lines have been measured (six (6) lines in total. Take the average of all recorded numbers, and if the units is not micrometers, convert it to micrometers (μm). This number is the embossment height. Repeat this procedure for another image in the fibrous structure product sample and take the average of the embossment heights.

### Flexural Rigidity Test Method

This test is performed on 1 inch×6 inch (2.54 cm×15.24 cm) strips of a fibrous structure sample. A Cantilever Bending Tester such as described in ASTM Standard D 1388 (Model 5010, Instrument Marketing Services, Fairfield, N.J.) is used and operated at a ramp angle of 41.5±0.5° and a sample slide speed of 0.5±0.2 in/second (1.3±0.5 cm/second). A minimum of n=16 tests are performed on each sample from n=8 sample strips.

No fibrous structure sample which is creased, bent, folded, perforated, or in any other way weakened should ever be tested using this test. A non-creased, non-bent, non-folded, non-perforated, and non-weakened in any other way fibrous structure sample should be used for testing under this test.

From one fibrous structure sample of about 4 inch×6 inch (10.16 cm×15.24 cm), carefully cut using a 1 inch (2.54 cm) JDC Cutter (available from Thwing-Albert Instrument Company, Philadelphia, Pa.) four (4) 1 inch (2.54 cm) wide by 6 inch (15.24 cm) long strips of the fibrous structure in the MD direction. From a second fibrous structure sample from the same sample set, carefully cut four (4) 1 inch (2.54 cm) wide by 6 inch (15.24 cm) long strips of the fibrous structure in the CD direction. It is important that the cut be exactly perpendicular to the long dimension of the strip. In cutting non-laminated two-ply fibrous structure strips, the strips should be cut individually. The strip should also be free of wrinkles or excessive mechanical manipulation which can impact flexibility. Mark the direction very lightly on one end of the strip, keeping the same surface of the sample up for all strips. Later, the strips will be turned over for testing, thus it is important that one surface of the strip be clearly identified, however, it makes no difference which surface of the sample is designated as the upper surface.

Using other portions of the fibrous structure (not the cut strips), determine the basis weight of the fibrous structure sample in lbs/3000 ft² and the caliper of the fibrous structure in mils (thousandths of an inch) using the standard procedures disclosed herein. Place the Cantilever Bending Tester level on a bench or table that is relatively free of vibration, excessive heat and most importantly air drafts. Adjust the platform of the Tester to horizontal as indicated by the leveling bubble and verify that the ramp angle is at 41.5±0.5°. Remove the sample slide bar from the top of the platform of the Tester. Place one of the strips on the horizontal platform using care to align the strip parallel with the movable sample slide. Align the strip exactly even with the vertical edge of the Tester wherein the angular ramp is attached or where the zero mark line is scribed on the Tester. Carefully place the sample slide bar back on top of the sample strip in the Tester. The sample slide bar must be carefully placed so that the strip is not wrinkled or moved from its initial position.

Move the strip and movable sample slide at a rate of approximately 0.5±0.2 in/second (1.3±0.5 cn/second) toward the end of the Tester to which the angular ramp is attached. This can be accomplished with either a manual or automatic Tester. Ensure that no slippage between the strip and movable sample slide occurs. As the sample slide bar and strip project over the edge of the Tester, the strip will begin to bend, or drape downward. Stop moving the sample slide bar the instant the leading edge of the strip falls level with the ramp edge. Read and record the overhang length from the linear scale to the nearest 0.5 mm. Record the distance the sample slide bar has moved in cm as overhang length. This test sequence is performed a total of eight (8) times for each fibrous structure in each direction (MD and CD). The first four strips are tested with the upper surface as the fibrous structure was cut facing up. The last four strips are inverted so that the upper surface as the fibrous structure was cut is facing down as the strip is placed on the horizontal platform of the Tester.

The average overhang length is determined by averaging the sixteen (16) readings obtained on a fibrous structure.

$$Overhang Length M D = \frac{Sum of 8 M D readings}{8}$$

$$Overhang Length C D = \frac{Sum of 8 C D readings}{8}$$

$$Overhang Length Total = \frac{Sum of all 16 readings}{16}$$

$$Bend Length M D = \frac{Overhang Length M D}{2}$$

$$Bend Length C D = \frac{Overhang Length C D}{2}$$

$$Bend Length Total = \frac{Overhang Length Total}{2}$$

$$Flexural Rigidity = 0.1629 \times W \times {C}^{3}$$

wherein W is the basis weight of the fibrous structure in lbs/3000 ft²; C is the bending length (MD or CD or Total) in cm; and the constant 0.1629 is used to convert the basis weight from English to metric units. The results are expressed in mg-cm, but are referred to only a cm.

### Average Wall Angle Test Method

A wall angle of an embossment can be measured using a GFM Mikrocad Optical Profiler instrument commercially available from GFMesstechnik GmbH, Warthestraβe 21, D 14513 Teltow/Berlin, Germany. The GFM Mikrocad Optical Profiler instrument includes a compact optical measuring sensor based on the digital micro mirror projection, consisting of the following main components: a) DMD projector with 1024×768 direct digital controlled micro mirrors, b) CCD camera with high resolution (1300×1000 pixels), c) projection optics adapted to a measuring area of at least 44 mm×33 mm, and d) matching resolution recording optics; a table tripod based on a small hard stone plate; a cold light source; a measuring, control, and evaluation computer; measuring, control, and evaluation software ODSCAD 4.0, English version; and adjusting probes for lateral (x-y) and vertical (z) calibration.

The GFM Mikrocad Optical Profiler system measures the surface height of a sample using the digital micro-mirror pattern projection technique. The result of the analysis is a map of surface height (z) vs. xy displacement. The system has a field of view of 48×36 mm with a resolution of 29 microns. The height resolution should be set to between 0.10 and 1.00 micron. The height range is 64,000 times the resolution.

To measure the wall angle of a embossment in an embossed fibrous structure the following can be performed: (1) Turn on the cold light source. The settings on the cold light source should be 4 and C, which should give a reading of 3000K on the display; (2) Turn on the computer, monitor and printer and open the ODSCAD 4.0 or higher Mikrocad Software; (3) Select “Measurement” icon from the Mikrocad taskbar and then click the “Live Pic” button; (4) Place an embossed fibrous structure sample, of at least 5 cm by 5 cm in size, under the projection head and adjust the distance for best focus; (5) Click the “Pattern” button repeatedly to project one of several focusing patterns to aid in achieving the best focus (the software cross hair should align with the projected cross hair when optimal focus is achieved). Position the projection head to be normal to the fibrous structure sample surface; (6) Adjust image brightness by changing the aperture on the camera lens and/or altering the camera “gain” setting on the screen. Set the gain to the lowest practical level while maintaining optimum brightness so as to limit the amount of electronic noise. When the illumination is optimum, the red circle at bottom of the screen labeled “I.O.” will turn green; (7) Select Standard measurement type; (8) Click on the “Measure” button. This will freeze the live image on the screen and, simultaneously, the surface capture process will begin. It is important to keep the sample still during this time to avoid blurring of the captured images. The full digitized surface data set will be captured in approximately 20 seconds; (9) Save the data to a computer file with “.omc” extension. This will also save the camera image file “.kam”; (10) Export the file to the FD3 v1.0 format; 11) Measure and record at least three areas from each sample; 12) Import each file into the software package SPIP (Image Metrology, A/S, Hørsholm, Denmark); 13) Using the Averaging profile tool, draw a profile line perpendicular to linear embossment transition region. Expand the averaging box to include as much of the embossment as practical so as to generate and average profile of the embossment transition region (from top surface to the bottom of the embossment and backup to the top surface.). In the average line profile window, select a pair of cursor points. Place the first cursor of the pair on the wall at a point that is at approximately 33% of the depth of the embossment. Place the second cursor of the pair at a point that is approximately 66% of the depth of the embossment. Read out the wall angle from the cursor information display and record it. Repeat this measure for at least 6 wall angles per sample data file.

To move the surface data into the analysis portion of the software, click on the clipboard/man icon; (11) Now, click on the icon “Draw Lines”. Draw a line through the center of a region of features defining the texture of interest. Click on Show Sectional Line icon. In the sectional plot, click on any two points of interest, for example, a peak and the baseline, then click on vertical distance tool to measure height in microns or click on adjacent peaks and use the horizontal distance tool to determine in-plane direction spacing; and (12) for height measurements, use 3 lines, with at least 5 measurements per line, discarding the high and low values for each line, and determining the mean of the remaining 9 values. Also record the standard deviation, maximum, and minimum. For x and/or y direction measurements, determine the mean of 7 measurements. Also record the standard deviation, maximum, and minimum. Criteria that can be used to characterize and distinguish texture include, but are not limited to, occluded area (i.e. area of features), open area (area absent of features), spacing, in-plane size, and height. If the probability that the difference between the two means of texture characterization is caused by chance is less than 10%, the textures can be considered to differ from one another.

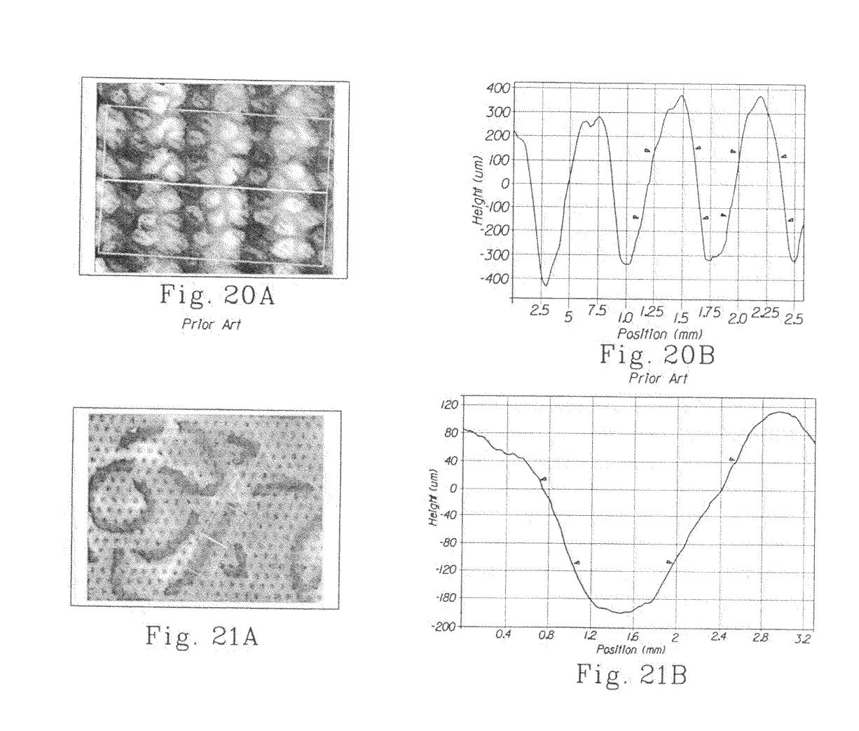

As shown in FIG. 20, a prior art embossed fibrous structure, which exhibits a ratio of average thickness of fibrous structure adjoining an embossment to average thickness of the embossment of about 1, exhibits an average wall angle of embossment of about 18° as measured by this test method.

As shown in FIG. 21, an embossed fibrous structure according to the present invention exhibits an average wall angle of embossment of about 28° as measured by this test method.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fibrous structure comprising an embossment, wherein the fibrous structure exhibits a ratio of average thickness of fibrous structure adjoining an embossment to average thickness of the embossment of less than 3 to about 1.2.

2. The fibrous structure according to claim 1 wherein the embossment exhibits an embossment depth of greater than 200 μm.

3. The fibrous structure according to claim 1 wherein the fibrous structure comprises a plurality of the embossments.

4. The fibrous structure according to claim 1 wherein the embossment is a line element embossment.

5. The fibrous structure according to claim 1 wherein the embossment is a dot embossment.

6. The fibrous structure according to claim 1 wherein the fibrous structure comprises a line element embossment at least partially surrounded by a line of a plurality of dot embossments.

7. The fibrous structure according to claim 1 wherein the fibrous structure exhibits a ratio of average thickness of fibrous structure adjoining an embossment to average thickness of the embossment of less than about 2.5.

8. The fibrous structure according to claim 1 wherein the fibrous structure exhibits a flexural rigidity of less than 10 cm.

9. The fibrous structure according to claim 1 wherein the fibrous structure exhibits a total dry tensile of greater than 59 g/cm.

10. The fibrous structure according to claim 1 wherein the fibrous structure comprises a softening agent.

11. The fibrous structure according to claim 1 wherein the fibrous structure comprises a temporary wet strength agent.

12. The fibrous structure according to claim 1 wherein the fibrous structure comprises a permanent wet strength agent.

13. A single- or multi-ply sanitary tissue product comprising a fibrous structure according to claim 1.

14. A process for making a fibrous structure, the process comprising the step of subjecting a fibrous structure to an embossing operation that creates an embossment in the fibrous structure that exhibits a ratio of average thickness of fibrous structure adjoining an embossment to average thickness of the embossment of less than 3 to about 1.2.

15. The process according to claim 14 wherein the embossing operation comprises passing the fibrous structure through a nip formed by a first embossing roll and a second embossing roll.

16. The process according to claim 15 wherein the first embossing roll comprises a male emboss pattern comprising one or more protrusions.

17. The process according to claim 16 wherein the first embossing roll further comprises a strain equalizing element adjoining to one or more of the protrusions.

18. The process according to claim 15 wherein the second embossing roll comprises a female emboss pattern.

19. The process according to claim 15 wherein the embossing operation applies a pressure to the fibrous structure of less than 80 pli.

20. The process according to claim 19 wherein the embossing operation applies a pressure to the fibrous structure of less than 60 pli.

21. The process according to claim 15 wherein at least one of the first and second embossing rolls exhibits an external diameter of less than 35 cm.

22. The process according to claim 14 wherein the embossment comprises a dot embossment.

23. The process according to claim 14 wherein the embossment comprises a line element embossment.

24. The process according to claim 15 wherein the first and second embossing rolls exhibit a Depth of Mesh of greater than 254 μm.

26. The process according to claim 15 wherein the first and second embossing rolls exhibit a Depth of Mesh of from about 381 μm to about 2032 μm.

27. The process according to claim 15 wherein the first and second embossing rolls exhibit a Lateral Clearance of greater than 75 μm.

28. The process according to claim 15 wherein the first and second embossing rolls exhibit a Lateral Clearance of from about 75 μm to about 700 μm.

29. The process according to claim 15 wherein the first and second embossing rolls exhibit a Lateral Clearance of from about 25% to about 85% of the average thickness of fibrous structure.

30. The process according to claim 14 wherein the embossing operation comprises the step of subjecting the fibrous structure to a strain in all directions including and between the machine and cross machine direction such that the fibrous structure experiences a maximum strain and a minimum strain that differs by less than 25% across all directions.

31. A fibrous structure comprising an embossment, wherein the fibrous structure exhibits a ratio of average thickness of fibrous structure adjoining an embossment to average thickness of the embossment of less than 3 and wherein the embossment exhibits an average wall angle of embossment as measured by the Average Wall Angle Test Method of greater than 22°.

32. A process for making a fibrous structure, the process comprising the step of subjecting a fibrous structure to an embossing operation that creates an embossment in the fibrous structure that exhibits a ratio of average thickness of fibrous structure adjoining an embossment to average thickness of the embossment of less than 3 and wherein the embossment exhibits an average wall angle of embossment as measured by the Average Wall Angle Test Method of greater than 22°.
